(19) United States
(12) Patent Application Publication
(10) Pub. No.: US 2006/0067513 A1
(43) Pub. Date: Mar. 30, 2006

(54) Multi-function telephone adapter

(75) Inventors: Benjamin Maytal, Mevaseret Zion (IL); Avi Avrahami, Kochav-Yair (IL)

Correspondence Address: WELSH & KATZ, LTD, 120 S RIVERSIDE PLAZA, 22ND FLOOR, CHICAGO, IL, 60606, US

(73) Assignee: SMARTLINK LTD., Netanya (IL)

(21) Appl. No.: 11/211,361

(22) Filed: Aug. 25, 2005

Related U.S. Application Data
(60) Provisional application No. 60/604,414, filed on Aug. 26, 2004.

(51) Int. Cl. H04M 9/00

(52) U.S. Cl. 379/395

(57) ABSTRACT

A telephone adapter includes a phone connector, for connecting to a telephone handset, and a line connector, for connecting to a telephone line of a circuit-switched telephone network. An analog front end (AFE) converts digital input samples received from the computer interface into analog audio signals, and converts the analog audio signals in the telephone adapter to digital output samples for transfer via the computer interface. Switching circuitry is coupled between the phone connector, line connector and AFE, and is controllable by a computer via a computer interface.

### CROSS-REFERENCE TO RELATED APPLICATION

This application claims the benefit of U.S. Provisional Patent Application 60/604,414, filed Aug. 26, 2004, which is incorporated herein by reference.

### FIELD OF THE INVENTION

The present invention relates generally to computer-integrated telephony, and specifically to methods and devices for integrating packet-switched and circuit-switched telephone equipment and services.

### BACKGROUND OF THE INVENTION

Analog telephone adapters are devices that convert the analog signals from a conventional telephone into a format acceptable for transmission over an Internet connection, and vice versa at the receiving end. A variety of products of this sort are available on the market. Examples include the HandyTone series, produced by Grandstream Networks; Sipura Phone Adapters, produced by Sipura Technology, Inc. (recently acquired by Cisco Systems); Quadro® Voice Routers, produced by Epygi® Technologies, Ltd.; FXS VoIP Gateway, produced by Micronet®; Messenger Call Box, produced by BAFO Inc.; Actiontec® Internet Phone Wizard, produced by Actiontec Electronics, Inc.; and M3 Motorola® Messenger Modem, produced by Motorola, Inc.

Various types and features of analog telephone adapters are described in the patent literature. For example, U.S. Pat. No. 6,700,956, whose disclosure is incorporated herein by reference, describes apparatus for selectively connecting a telephone to a telephone network or to the Internet. The apparatus comprises a hardware module and associated software for coupling a personal computer or Internet appliance and a standard analog telephone. The apparatus permits the analog telephone to be toggled between an Internet-based telephone mode and a public switched telephone network (PSTN) mode by inputting a predetermined sequence of dual-tone multi-frequency (DTMF) digits.

### SUMMARY OF THE INVENTION

Embodiments of the present invention provide analog telephone adapter devices and methods for use of such devices that include novel features not suggested by the prior art. These features enhance the versatility, cost-effectiveness and ease of use of integrated analog/packet telephone systems.

In disclosed embodiments of the present invention, a telephone adapter couples a computer to an analog telephone and to a circuit-switched telephone network line, such as a PSTN line. Since both the telephone and the line typically connect to the telephone adapter using the same sort of cable connector (such as a RJ-11 connector), the telephone adapter may comprise a jack swap detection circuit, which automatically alerts the user when the connections are accidentally reversed. The user may dial outgoing calls to the switched telephone network using the analog telephone in the usual manner, or may alternatively direct outgoing calls via the computer to a packet network, such as the Internet. The computer directs incoming calls on the packet network to the analog telephone after first checking that the analog telephone is on hook. If the analog telephone is off hook (typically due to a call in progress on the switched telephone network), the computer notifies the user, typically by displaying a message on screen, which may be accompanied by a tone or other signal.

The telephone adapter typically comprises an analog front end (AFE), which couples the analog telephone to the digital circuits of the computer. In some embodiments of the present invention, the same AFE may be switched to couple the computer to the circuit-switched telephone network line in order to provide modem service (such as fax or data modem service) via the switched telephone network under control of software running on the computer. Additionally or alternatively, this switching function may be used in providing novel combinations of packet telephony and analog telephone services, such as conference calls involving other subscribers on both the packet and circuit-switched networks.

There is therefore provided, in accordance with an embodiment of the present invention, a telephone adapter, including:
a phone connector, for connecting to a telephone handset;
a line connector, for connecting to a telephone line;
a computer interface, for connecting to a computer; and
a jack swap detector, which is coupled to sense a voltage on at least one of the phone connector and the line connector while the telephone handset is disconnected from the telephone line so as to detect, responsively to the voltage, whether the telephone handset and telephone line have been properly connected.

In disclosed embodiments, the adapter includes a switch, which is operative selectably under control of the computer to connect the phone connector to the line connector, so as to permit the handset to be used in a telephone call via the telephone line, and to disconnect the phone connector from the line connector for testing by the jack swap connector. Typically, the jack swap detector is coupled to provide an input to the computer via the computer interface in order to enable the computer determine whether the telephone handset and telephone line have been properly connected, so as to cause the computer to notify a user upon detection of improper connection of the telephone handset and telephone line. Additionally or alternatively, the input causes the computer to set the switch to disable the adapter upon detection of improper connection of the telephone handset and telephone line.

In some embodiments, the adapter includes an analog front end (AFE), coupled between the phone connector, line connector and computer interface, and arranged to convert digital input samples received from the computer via the computer interface into analog signals, and to convert the analog signals in the telephone adapter to digital output samples for transfer to the computer via the computer interface. The adapter may also include switching circuitry, which is controllable by the computer via the computer interface so as to enable the telephone handset to be used as an audio input/output (I/O) device for a packet telephony application running on the computer.

There is also provided, in accordance with an embodiment of the present invention, communication apparatus, including:
a telephone adapter, including:
   a phone connector, for connecting to a telephone handset;
   a line connector, for connecting to a telephone line;
   a computer interface; and
   a jack swap detector, which is coupled to detect whether the telephone handset and telephone line have been properly connected; and
a computer, which is coupled to the computer interface so as to receive an input from the jack swap detector indicating whether the telephone handset and telephone line have been properly connected, and to take protective action upon detection of improper connection of the telephone handset and telephone line.

There is additionally provided, in accordance with an embodiment of the present invention, a telephone adapter, including:
a phone connector, for connecting to a telephone handset;
a line connector, for connecting to a telephone line of a circuit-switched telephone network;
a computer interface, for connecting to a computer;
an analog front end (AFE), for converting digital input samples received from the computer via the computer interface into analog audio signals, and for converting the analog audio signals in the telephone adapter to digital output samples for transfer to the computer via the computer interface; and
switching circuitry, coupled to convey the analog audio signals simultaneously between the phone connector, line connector and AFE, so as to connect a first subscriber using the telephone handset in a conference call with a second subscriber on the circuit-switched telephone network and with a third subscriber in communication with the computer via a packet-switched network.

There is further provided, in accordance with an embodiment of the present invention, communication apparatus, including:
a telephone adapter, including:
   a phone connector, for connecting to a telephone handset;
   a line connector, for connecting to a telephone line of a circuit-switched telephone network;
   a computer interface;
   an analog front end (AFE), for converting digital input samples received from the computer interface into analog audio signals, and for converting the analog audio signals in the telephone adapter to digital output samples for transfer via the computer interface; and
   switching circuitry, coupled between the phone connector, line connector and AFE; and
a computer, which is coupled to the telephone adapter via the computer interface and is arranged to set the switching circuitry to convey the analog audio signals simultaneously between the phone connector, line connector and AFE, so as to connect a first subscriber using the telephone handset in a conference call with a second subscriber on the circuit-switched telephone network and with a third subscriber in communication with the computer via a packet-switched network.

In disclosed embodiments, the computer is arranged to establish a Voice over Internet Protocol (VoIP) call over the packet-switched network with the third subscriber, and to convert the digital output samples to packetized audio data for transmission in the VoIP call. Typically, the computer is arranged to establish the VoIP call between the first and third subscribers, and responsively to a signal from the first subscriber during the VoIP call, to control the switching circuitry so as to permit a telephone call to be placed between the telephone handset and the second subscriber and to conference the telephone call with the VoIP call. The adapter and the computer may be arranged so as to permit the telephone call to be placed between the telephone handset and the second subscriber without interrupting the VoIP call.

Additionally or alternatively, the computer is arranged to control the switching circuitry so as to permit a telephone call to be placed between the telephone handset and the second subscriber, and responsively to a signal from the first subscriber during the telephone call, to establish the VoIP call with the third subscriber and to control the switching circuitry so as to conference the telephone call with the VoIP call. Typically, the computer is arranged, upon receiving a request from the third subscriber to establish the VoIP call while the telephone call is in progress, to determine that the telephone adapter is in use and to issue a notification to the user indicating that the request is pending.

In one embodiment, the computer is operative in a voice communication mode to transmit and receive digital audio samples via the computer interface so as to cause the AFE to convey analog audio signals to and from the telephone handset, and is operative in a modem communication mode to transmit and receive digital modem samples via the computer interface so as to cause the AFE to convey modem signals corresponding to the digital output and input data to and from the telephone line.

There is moreover provided, in accordance with an embodiment of the present invention, communication apparatus, including:
a telephone adapter, including:
   a phone connector, for connecting to a telephone handset;
   a line connector, for connecting to a telephone line of a circuit-switched telephone network;
   a computer interface; and
   an analog front end (AFE), coupled between the phone connector, line connector and computer interface, and arranged to convert digital input samples received via the computer interface into analog signals, and to convert the analog signals in the telephone adapter to digital output samples for transfer via the computer interface; and
a computer, which is coupled to the telephone adapter through the computer interface, and which is operative in a voice communication mode to transmit and receive digital audio samples via the computer interface so as to cause the AFE to convey analog audio signals to and from the telephone handset, and which is operative in a modem communication mode to transmit and receive digital modem samples via the computer interface so as to cause the AFE to convey modem signals corresponding to digital output and input data to and from the telephone line.

In a disclosed embodiment, the telephone adapter includes switching circuitry, coupled to selectably convey the analog signals between the phone connector, line connector and AFE, and the computer is coupled to control the switching circuitry via the computer interface.

Additionally or alternatively, the computer is arranged to run a soft modem program, for processing the digital output data to generate the digital output samples for conveyance to the AFE and for processing the digital input samples received from the AFE to generate the digital input data. Typically, the soft modem program is operative in accordance with at least one of an analog modem standard and a fax modem standard.

There is furthermore provided, in accordance with an embodiment of the present invention, communication apparatus, including:
a telephone adapter, including:
   a phone connector, for connecting to a telephone handset;
   a line connector, for connecting to a telephone line of a circuit-switched telephone network, and coupled to the phone connector so as to establish a first telephone call between the telephone handset and a subscriber on the circuit-switched telephone network;
   a computer interface; and
   an analog front end (AFE), coupled between the phone connector and the computer interface, and arranged to convert digital input samples received via the computer interface into analog audio signals, and to convert the analog audio signals in the telephone adapter to digital output samples for transfer via the computer interface; and
a computer, which is coupled to the telephone adapter through the computer interface, and which is further coupled to receive a request to open a second telephone call over a packet-switched network and, responsively to the request, to determine that the telephone adapter is in use on the first telephone call and to issue a notification to the user indicating that the request is pending.

There is also provided, in accordance with an embodiment of the present invention, a method for communication, including:
providing a telephone adapter that includes a phone connector, for connecting to a telephone handset, a line connector, for connecting to a telephone line, and a computer interface, for connecting to a computer; and
after a user has connected the telephone handset and the telephone line to the telephone adapter, sensing a voltage on at least one of the phone connector and the line connector while disconnecting the telephone handset from the telephone line so as to detect, responsively to the voltage, whether the telephone handset and telephone line have been properly connected.

There is additionally provided, in accordance with an embodiment of the present invention, a method for communication, including:
connecting a telephone handset, a telephone line, and a computer to a telephone adapter;
connecting a first subscriber using the telephone handset via the telephone adapter in a conference call with a second subscriber on the circuit-switched telephone network and with a third subscriber in communication with the computer through a packet-switched network; and
during the conference call, operating the telephone adapter to convert digital input samples received from the computer via the computer interface into analog audio signals, and to convert the analog audio signals in the telephone adapter to digital output samples for transfer to the computer via the computer interface, and simultaneously to convey the analog audio signals between the telephone adapter and the telephone handset and telephone line so as to permit the first, second and third subscribers to converse.

There is further provided, in accordance with an embodiment of the present invention, a method for communication, including:
connecting a telephone handset, a telephone line, and a computer to a telephone adapter, which is arranged to convert digital input samples received from the computer into analog signals for output to the telephone handset and the telephone line, and to convert the analog signals received from the telephone handset and the telephone line to digital output samples for transfer to the computer;
operating the computer in a voice communication mode to transmit and receive digital audio samples via the computer interface so as to cause the telephone adapter to convey analog audio signals to and from the telephone handset; and
operating the computer in a modem communication mode to transmit and receive digital modem samples via the computer interface so as to cause the AFE to convey modem signals corresponding to digital output and input data to and from the telephone line.

There is moreover provided, in accordance with an embodiment of the present invention, a method for communication, including:
connecting a telephone handset, a telephone line and a computer to a telephone adapter, which is arranged to convert digital input samples received from the computer into analog signals for output to the telephone handset and the telephone line, and to convert the analog signals received from the telephone handset and the telephone line to digital output samples for transfer to the computer;
establishing a first telephone call, using the telephone adapter, between the telephone handset and a subscriber on the circuit-switched telephone network;
receiving a request at the computer to open a second telephone call over a packet-switched network while the telephone adapter is in use on the first telephone call; and
responsively to the request, notifying the user that the request is pending.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a telephone communication system, in accordance with an embodiment of the present invention;

FIG. 2 is a block diagram that schematically shows details of a telephone adapter, in accordance with an embodiment of the present invention; and

FIG. 3 is a block diagram that schematically shows details of software that runs on a computer in conjunction with a telephone adapter, in accordance with an embodiment of the present invention.

### DETAILED DESCRIPTION OF EMBODIMENTS

### System Overview

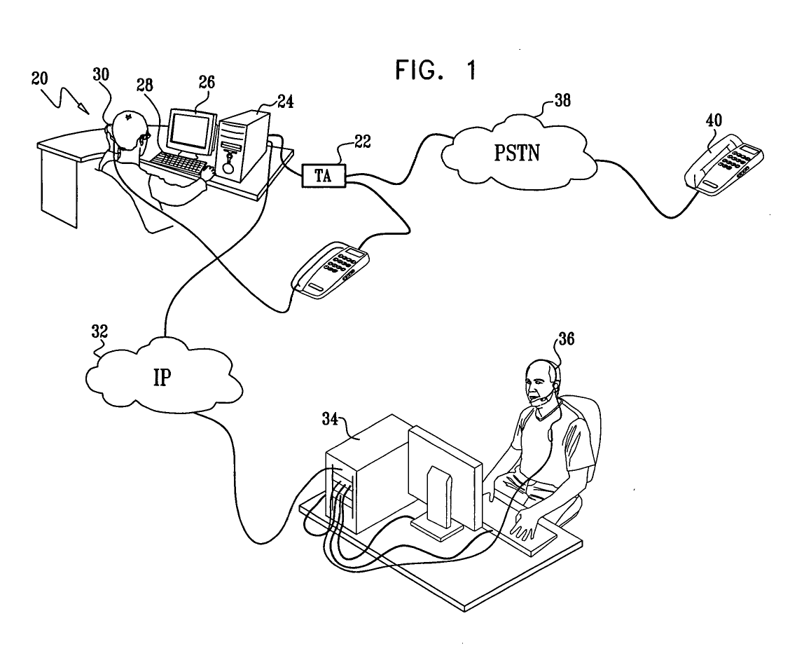

FIG. 1 is a schematic, pictorial illustration of a telephone communication system 20, in accordance with an embodiment of the present invention. System 20 combines conventional analog and packet-switched telephone network components using a telephone adapter (TA) 22, to provide a novel set of features and functions, which are described hereinbelow.

Adapter 22 is used in conjunction with a computer 24, typically a personal computer (PC), which comprises a user interface including a display 26 and one or more input devices 28, such as a keyboard or mouse. (Alternatively, computer 24 may comprise any other sort of suitable computing device having a CPU; and computer 24 is referred to hereinbelow as a PC solely by way of example, and not limitation.) Adapter 22 may connect to the PC through a suitable digital input/output (I/O) port, such as a Universal Serial Bus (USB) port, or through a local area network (LAN). Alternatively, the adapter may be configured as a plug-in card or other component, which may be housed inside computer 24.

Adapter 22 also communicates with an analog telephone handset 30 and with a circuit-switched telephone network 38. Typically, network 38 is a PSTN, and adapter 22 connects to the PSTN and to handset 30 via suitable cables. Alternatively, telephone 30 may communicate over the air with adapter 22 via a cordless connection. Further alternatively, telephone handset 30 and adapter 22 may be integrated into a single device. Further alternatively or additionally, network 38 may comprise another type of circuit-switched telephone network, such as a cellular network. Adapter 22 is configured, as described hereinbelow, to permit users to place and receive telephone calls using handset 30 via network 38 to and from other analog telephones 40. For clarity in the description that follows, such calls will be referred to as “PSTN calls,” but it will be understood that calls on other types of circuit-switched networks may be handled in similar fashion.

Computer 24 is also connected to a packet-switched network 32, such as the Internet via a suitable modem (not shown). Typically, in order to enable high-quality Voice over IP (VoIP) service, the connection to network 32 is a broadband connection, such as a DSL, cable modem or ISDN connection. Alternatively, an analog modem connection, such as a V.90 or V.92 modem connection, may be adequate for some VoIP applications. The user of computer 24 is then able to use handset 30, via adapter 22, as an I/O device for placing and receiving VoIP calls via network 32 to and from other VoIP-enabled terminals, such as computers 34 that are equipped with suitable VoIP software and audio interface equipment 36 or with a telephone adapter such as adapters 22, as well as with non-PC VoIP devices.

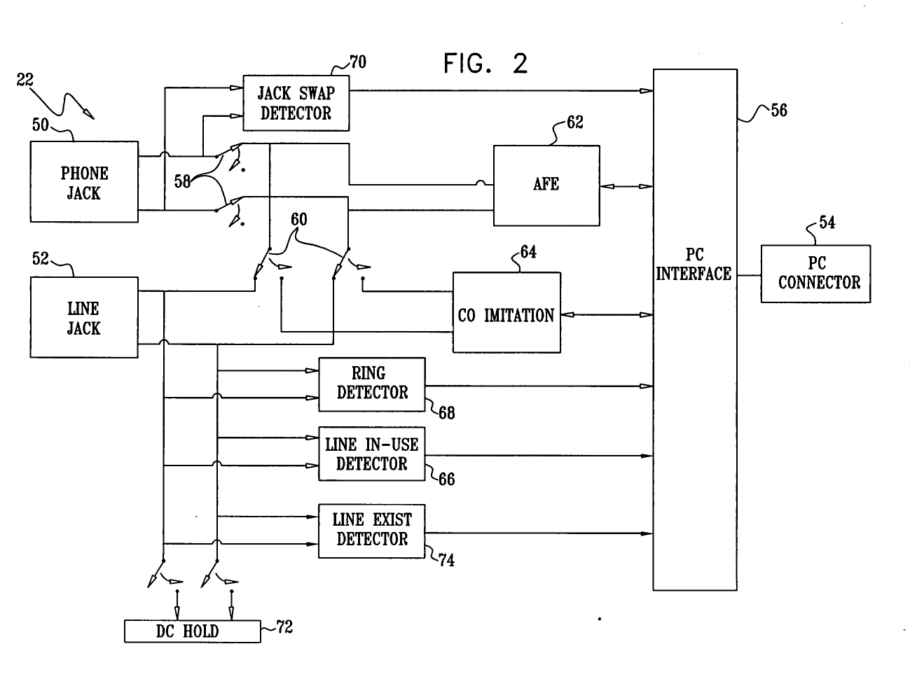

FIG. 2 is a block diagram that schematically shows details of telephone adapter 22, in accordance with an embodiment of the present invention. For the sake of conceptual clarity in the explanation that follows, adapter 22 is shown as comprising certain functional blocks. Not all of these blocks are essential to all aspects of operation of the adapter, as will be apparent from the explanation. Furthermore, in practical implementations, some of these blocks may be combined into a single physical element, such as an integrated circuit chip. Alternatively or additionally, certain blocks may be made up of multiple discrete components. Various alternative implementations of the circuitry in adapter 22 will be apparent to those skilled in the art; and all such implementations are considered to be within the scope of the present invention.

Adapter 22 comprises a phone jack 50, for connecting to telephone handset 30, and a line jack 52, for connecting to network 38. Typically, jacks 50 and 52 comprise standard cable connectors, such as RJ-11 receptacles.

On the PC side, adapter 22 comprises a PC connector 54, which is coupled to the other elements of the adapter via a PC interface 56. As noted above, connector 54 may comprise a USB connector, in which case PC interface 56 comprises interface hardware and I/O logic for multiplexing digital input and output data to and from the elements of adapter 22 over the USB link. Alternatively, connector 54 may comprise a LAN connector, in which case PC interface 56 comprises suitable LAN interface circuits. Further alternatively, for embodiments in which adapter 22 is housed inside computer 24, connector 54 may comprise a PC bus connector, such as a Peripheral Component Interface (PCI) bus connector or an Intel® High Definition (HD) Audio connection, with suitable bus interface logic in PC interface 56. The circuits in adapter 22 may draw power from computer 24, if the computer is configured to provide power via connector 54, or the circuits may alternatively be powered by a battery or other power supply (not shown) in adapter 22.

Adapter 22 comprises switches 58 and 60, which are controlled by computer 24 via interface 56 in order to determine the operational mode of the adapter. In the setting shown in FIG. 2, switches 58 and 60 couple telephone handset 30 directly to network 38 via jacks 50 and 52, so that the user can place and receive ordinary analog telephone calls in the usual manner without involvement of the computer. As long as the handset is on hook, incoming calls from network 38 will cause the telephone to ring normally.

Since jacks 50 and 52 may be outwardly identical, it is possible that a user of adapter 22 will accidentally reverse the telephone and line connections. Such a reversal might damage the components of adapter 22 and could violate safety requirements. Although reversal of the connections will not prevent handset 30 from being used in ordinary calls over network 38, it will disrupt the VoIP- and modem-related functions of adapter 22 that are described hereinbelow. Therefore, adapter 22 comprises a jack swap detector 70 for detecting and alerting the user to possible reversal of the connections.

To operate detector 70, computer 34 actuates switches 58, so that the switches move to the lower position shown in FIG. 2, in which phone jack 50 is isolated from AFE 62 and from line jack 52. Detector 70 then measures the voltage on the phone jack. In the lower position of switches 58, if handset 30 is correctly connected to phone jack 50, there will be no voltage on the jack. Upon receiving the “no voltage” indication from detector 70, computer 24 returns switches 58 to the upper position shown in FIG. 2, and permits the adapter to continue normal operation. If detector 70 does measure substantial voltage on phone jack 50, however, it can be taken as an indication that phone jack 50 has been connected incorrectly to the telephone line. In this case, computer 24 notifies the user of the improper connection by means of an audible tone and/or a message on display 26. Additionally or alternatively, the functionality of adapter 22 may be automatically disabled (for example, by setting switches 58 to the lower position) to protect against damage to equipment and possible risk to the user. Computer 24 typically performs this jack swap test when the computer or adapter 22 is powered up, and optionally repeats the test intermittently when adapter 22 is not in use.

Additionally or alternatively, adapter 22 may comprise a line existence detector 74, which measures the voltage on line jack 52 and thus permits computer 24 to determine whether a telephone line is connected to the line jack. If no line connection is detected, the computer notifies the user of the error and disables line-related functions, such as soft modem operation, as described below.

For purposes of digital services and interaction with computer 24, an analog front end (AFE) 62 couples handset 30 to computer 24 by way of interface 56. AFE 62 typically comprises analog/digital (A/D) and digital/analog (D/A) converters, as well as the data access arrangement (DAA) that is required for connection of computer 24 to telephone network 38. These standard AFE components are well known in the art and are omitted from the figures for the sake of simplicity. In the position of switches 58 that is shown in FIG. 2, the AFE samples and digitizes analog audio signals from handset 30 for input to computer 24 and converts digital audio samples from computer 24 to analog audio signals for conveyance to handset 30. This functionality permits handset 30 to be used in VoIP calls via computer 24 over network 32. In addition, AFE 62 may be used in enabling computer 24 to monitor certain audio signals generated during telephone calls using handset 30, such as DTMF tones generated when the user presses telephone keys, for purposes of advanced control functions. Some examples of these functions are described hereinbelow.

In general, when handset 30 is used in placing or receiving VoIP calls over network 32, computer 24 moves switches 60 to the right-hand position in FIG. 2, so that the handset is disconnected from the telephone line. (Alternatively, for some of the special services described hereinbelow, such as teleconferencing, switches 60 may be held in the left-hand position during a VoIP call, so that the telephone handset is simultaneously coupled to network 38.) With switches 60 in the right-hand position, handset 30 is coupled to a central office (CO) imitation circuit 64, which provides the requisite DC voltage (normally drawn from the telephone line) for operation of the handset. Circuit 64 may also be operated by computer 24 to ring handset 30 in order to notify the user of an incoming VoIP call, as well as to determine when the handset is off hook.

To facilitate implementation of advanced control functions by computer 24, adapter 22 may comprise a line use detector 66 and a ring detector 68. The line use detector indicates to the computer when there is a call in progress via adapter 22 or any other telephone connected to the same line on network 38. The ring detector can be used by the computer to detect ringing on the telephone line that is connected to line jack 52 even when handset 30 is off hook (during a VoIP call, for example). The computer may switch a DC hold circuit 72 across the line jack so that adapter continues to draw current from the central office of network 38 even when switches 60 are in the right-hand position. This feature enables computer 24 to keep a call open on network 38 even when handset 30 is in use for another purpose, such as when the user wishes to keep a call with telephone 40 on hold while using handset 30 to place or receive a VoIP call. DC hold circuit 72 is also used when adapter 22 is required to provide fax and/or other modem service over network 38, as described hereinbelow.

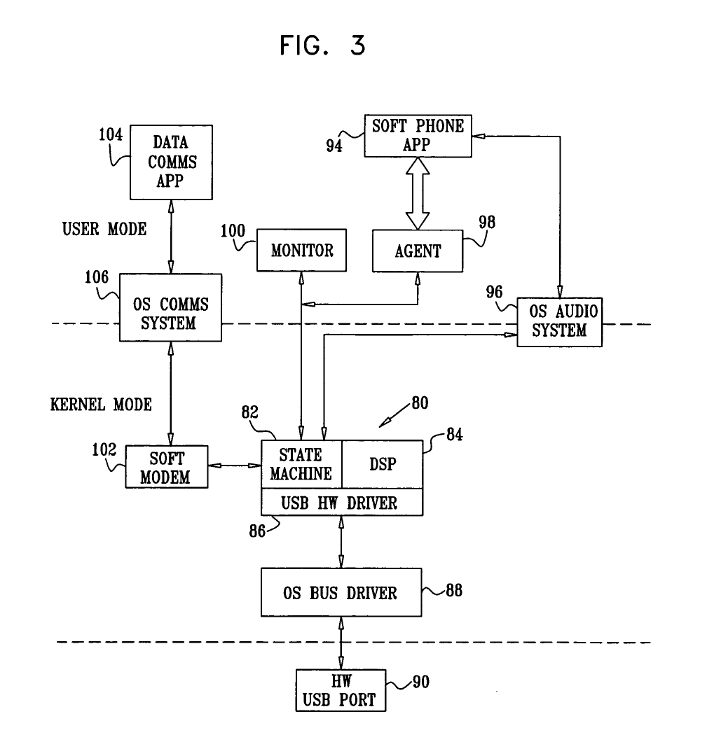

FIG. 3 is a block diagram that schematically illustrates software that runs on computer 24 in conjunction with adapter 22, in accordance with an embodiment of the present invention. The core of the software is a state machine 82, which comprises a library of routines for handling different call situations, such as incoming and outgoing VoIP call events, as well as switching between VoIP and PSTN operation and conferencing VoIP and PSTN calls. Exemplary situations and functions are described hereinbelow.

State machine 82 is linked to a digital signal processing (DSP) function 84, which may optionally be used to convert digital audio samples from AFE 62 (FIG. 2) into the format required by an audio system program 96 of the operating system of computer 24. Additionally or alternatively, the DSP function may be used in converting audio data streams from audio system 96 to digital audio samples for input to AFE 62. This conversion may also include sample rate conversion. The DSP function may apply one or more of the following sorts of algorithms to the samples flowing between AFE 62 and audio system program 96: echo cancellation, voice activation detection (VAD), DTMF detection and generation, silence and activity detection, comfort noise generation (CNG), and any other suitable type of digital processing known in the art. The state machine tracks the state of calls in progress and invokes DSP 84 as required.

State machine 82 sends and receives digital audio samples and control data to and from adapter 22 via a hardware (HW) driver 86. This driver controls the bi-directional transfer of the data samples and controls in a manner suited to the specific interface used between adapter 22 and computer 24. In the present example, it is assumed that the adapter and computer are connected by a USB cable, and driver 86 is therefore identified in the figure as a USB HW driver. Driver 86 sends and receives USB messages via a bus driver 88 to and from a USB port 90 of computer 24. Bus driver 88 is typically a standard part of the operating system (such as Microsoft® Windows®) running on computer 24. Alternatively, if adapter 22 is coupled to computer 24 by a different sort of bus or network connection, such as the types mentioned above, drivers 86 and 88 and port 90 may be replaced by other software and hardware components, as will be apparent to those skilled in the art.

In some embodiments of the present invention, state machine 82 is configured to work with one or more third-party soft phone applications 94, such as Skype™. Application 94 handles the communication tasks associated with sending and receiving VoIP calls over network 32, such as setting up and terminating calls using the Session Initiation Protocol (SIP), and transmitting and receiving audio data packets over network 32 using the appropriate codec and upper-level communication protocols. The audio data carried in these packets is transferred to and from telephone handset 30 via adapter 22, using OS audio system 96 and DSP 84, as described above. On the control plane, state machine 82 communicates with soft phone application 94 via a software agent 98. Agent 98 interacts with an application program interface (API) of application 94 that enables the agent to receive event messages from application 94 indicating changes in the call state and to pass instructions to the application regarding handling of the call.

A monitor 100 displays messages from state machine 82 on display 26 and enables the user of computer 24 to interact with the state machine and with adapter 22 via input device 28. In addition, the connection to soft phone application 94 via agent 98 permits the user to control VoIP calls by means of the user interface of handset 30, which typically includes the telephone keypad and hook switch.

In some embodiments of the present invention, as noted above, adapter 22 and the accompanying software on computer 24 are configured to provide modem services, such as fax and/or data modem service, over network 38, in addition to the voice telephony functions described thus far. State machine 82 decides whether to operate adapter 22 in telephone mode or modem mode depending on input by the user of computer 24. For modem operation, a soft modem routine 102 converts digital data generated by a data communication application 104 running on computer 24 to a stream of digital samples for conversion to analog signals by AFE 62, and similarly converts incoming digital samples from AFE 62 to digital data. Application 104 may comprise a Web browser, an e-mail program or a computer fax program, for example. The application communicates with soft modem routine 102 via a communications system program 106 of the operating system of computer 24, such as TAPI (Telephony Application Program Interface) under Microsoft Windows. Soft modem routine 102 determines the format for conversion from data to samples and vice versa depending on the applicable modem standard. Soft modem programs that may be used for this purpose are provided by various vendors, such as Smart Link (Netanya, Israel).

### Use Scenarios

Placing Outgoing Calls

To place a PSTN call over circuit-switched network 38, the user simply picks up telephone 30 and dials.

To place a call over packet network 32, the user picks up telephone handset 30 and selects VoIP service, typically by pressing a special key sequence on telephone 30. AFE 62 digitizes the DTMF tones generated by the key sequence, and state machine 82 decodes the user command based on the digitized tones. Alternatively, the user may select VoIP mode by an appropriate input to computer 24 (for example, clicking on an icon on display 26) or by pressing a button on adapter 22 (not shown).

Upon receiving the command to enter VoIP mode, state machine 82 sets switches 58 to the upper position and sets switches 60 to the right position. The user then dials the desired VoIP telephone number using handset 30. Again, state machine 82 decodes the digits and passes the number to soft phone application 94, which sets up the call. Handset 30 serves as the audio I/O device for the remainder of the call.

Receiving Incoming PSTN Calls

Adapter 22 and state machine 82 may be configured to provide the user with a “call waiting” signal when a VoIP call comes in while the user is conducting a PSTN call on network 38. Additionally or alternatively, the adapter and state machine may be configured to provide the “call waiting” signal when a PSTN call comes in on network 38 while the user is conducting a VoIP call. Further alternatively, adapter 22 and the accompanying software may be furnished without such capabilities, or the user may disable them by appropriate software commands.

When a PSTN call is placed to the user over network 38, and there is no VoIP call in progress, handset 30 rings normally. If a call comes in from network 38 while handset 30 is in use on a VoIP call, and “call waiting” is not activated, handset 30 will not ring or receive the call. Other telephone extensions on the same line will still ring, however, since switches 60 disconnect phone jack 50 from line jack 52.

If “call waiting” is activated, on the other hand, and a PSTN call comes in from network 38 while handset 30 is in use on a VoIP call, ring detector 68 signals state machine 82 to indicate that the telephone line is ringing. The state machine then signals the user to indicate that a telephone call from network 38 is waiting. The signal to the user may take several possible forms, for example:
An audio signal generated by the state machine and transmitted via PC interface 56 to AFE 62, in order to create a beep or other sound via handset 30.
An audio signal generated by the state machine and played by an audio speaker (not shown) of computer 24.
A visual message presented on display 26.

In response to the signal, the user of handset 30 may put the current VoIP call on hold and take the PSTN call by dialing a predefined code on the handset keypad or providing an input directly to computer 24, for example by selecting an icon on display 26. Upon detecting the user input, state machine 82 may instruct soft phone application 94 to put the VoIP call on hold, and instruct adapter 22 to move switches 60 to the left-hand position in order to pick of the waiting PSTN call. After completing the PSTN call, the user once again presses a certain sequence of keystrokes or makes an appropriate input to computer 24, and the VoIP call resumes.

Receiving Incoming VoIP Calls

When soft phone application 94 receives an incoming VoIP call, it notifies state machine 82, which checks line use detector 66 to determine whether a PSTN call is in progress. If there is no such call in progress, the state machine instructs adapter 22 to move switches 60 to the right-hand position, and instructs CO imitation circuit 64 to ring handset 30. Additionally or alternatively, the state machine may prompt the audio system of computer 24 to sound a ring or other tone, or may generate a visual message on display 26. When circuit 64 detects that the user has picked up the handset, it informs state machine 82, which then causes audio data to be conveyed to and from the handset via interface 56 and AFE 62 for the duration of the VoIP call.

If “call waiting” is not activated, and an incoming VoIP call is received while handset 30 is in use on a telephone network call, state machine 82 may instruct application 94 to decline the VoIP call or may route the call to the audio system of computer 24.

If “call waiting” is activated, state machine 82 may prompt the user with an audio signal and/or a message on display 26 to indicate that a VoIP call is waiting (in substantially the same manner as was described above regarding a waiting PSTN call during a VoIP call). The user may accept the waiting VoIP call by dialing the appropriate code on handset 30 or making an appropriate input to computer 24. In this case, state machine 82 instructs adapter to close the switches between DC hold circuit 72 and line jack 52, and to shift switches 60 to the right-hand position. The DC hold circuit draws current via line jack 52 so that the central office circuits on network 38 continue to sense that the PSTN call is ongoing, even though handset 30 has been temporarily disconnected from the call.

After completing the VoIP call, the user once again presses a certain sequence of keystrokes or makes an appropriate input to computer 24. Switches 60 and DC hold circuit 72 return to their previous positions, and the PSTN call resumes.

Conference Calls

In this mode of operation, the user of handset 30 may conference together a call on circuit-switched telephone network 38 and a call on packet network 32. In the example that follows, it will be assumed that the three-way conference call includes handset 30, analog telephone 40 and computer 34 (FIG. 1). The audio signals are mixed together in the analog circuits of adapter 22, as described hereinbelow. If soft phone application 94 is also capable of conferencing together a number of VoIP calls, this capability may be used to create an analog conference call on adapter 22 in which multiple VoIP users may confer together with the users of handset 30 and telephone 40.

If a VoIP call is in progress between computers 24 and 34 (with adapter 22 and handset 30 configured to communicate via computer 24), the user of computer 24 may request initiation of a conference call by entering a predetermined set of keystrokes on handset 30 or by providing another appropriate input to computer 24, such as selecting an icon on display 26. Upon receiving the user request, state machine 82 instructs adapter 22 to shift switches 60 to the left-hand position. In this position, handset 30 is connected both to continue the VoIP call via AFE 62 and to carry on the analog call to telephone 40 via network 38. Upon hearing the dial tone from network 38, the user dials the number of telephone 40. After telephone 40 picks up, analog audio signals will be conveyed from both handset 30 and AFE 62 over network 38 to telephone 40; and analog audio signals from telephone 40 will be simultaneously conveyed to handset 30 and digitized by AFE 62 for VoIP transmission to computer 34.

If a VoIP call is in progress between computers 24 and 34, and the user of computer 24 receives a “call waiting” signal indicating that a PSTN call is coming in over network 38 from telephone 40 (as described above), the user may also choose to conference the calls together. Again, the user chooses the conference option by dialing a predetermined code on handset 30 or making an appropriate input to computer 24. State machine 82 then instructs adapter 22 to shift switches 60 to the left-hand position, and the conference call proceeds as described above.

Similarly, if a PSTN call is in progress between handset 30 and analog telephone 40, and the user of handset 30 wishes to conference in computer 34, the user dials the appropriate code on handset 30 or makes the appropriate input to computer 24 to request a conference. In this case, switches 60 are already in the left-hand position. State machine 82 prompts the user to input the VoIP telephone number for computer 34, via either the keypad of handset 30 or using input device 28. When the VoIP call is connected, the conference call proceeds via adapter 22, as described above. A conference call may be initiated in similar fashion when the user of handset 30 receives a VoIP “call waiting” signal while on a PSTN call with telephone 40.

Soft Modem Operation

Modem operation is invoked when the user of computer 24 selects this mode of operation, or automatically when an application program on computer 24 has data to send or receive. Depending on user and/or application inputs, state machine 82 decides whether to operate adapter 22 in the usual telephony mode described above or in modem mode, for data or fax service. As noted above, the same AFE 62 is used for both voice and modem services without alteration or reconfiguration. The difference between voice and modem modes is in software: the choice of DSP function 84 or soft modem routine 102 to process the digital samples.

Upon actuation of data mode, state machine 82 instructs adapter 22 to shift switches 58 to the lower position, thus disconnecting handset 30 from the call. Switches 60 are held in the left-hand position, in order to connect AFE 62 to line jack 52. The switches on DC hold circuit 72 are closed in order to draw current from the telephone line, thus keeping the connection open to the central office, as described above. Data communications then continue until the modem session is completed.

While adapter 22 operates in modem mode, handset 30 is disconnected. If the user of computer 24 wishes to place or receive a VoIP call during this time, the computer audio system can be used for this purpose.

Automatic Call Forwarding

State machine 82 may also be configured to perform automatic call forwarding, to a forwarding number specified by the user of computer 24. For example, the state machine may be configured so that when a VoIP call comes into computer 24, and no one picks up the call for a certain period of time, the state machine automatically dials a forwarding number on network 38 that the user has specified. When this latter number picks up, the state machine connects the PSTN call on network 38 with the VoIP call on network 32, using AFE 62 to convert audio signals to digital samples and vice versa. This inter-mode connection is similar in operation to the conference calling modes described above, except that in the present case, handset 30 does not participate in the conference call.

In similar fashion, state machine 82 may be configured so that when ring detector 68 senses an incoming call from network 38, the state machine places a VoIP call to a designated number on network 32. When the VoIP number answers, DC hold circuit 72 is switched across line jack 52 to pick up the PSTN call. Switches 58 and 60 in adapter 22 are set to the state used for analog conferencing of PSTN and VoIP calls, as described above.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A telephone adapter, comprising:
a phone connector, for connecting to a telephone handset;
a line connector, for connecting to a telephone line;
a computer interface, for connecting to a computer; and
a jack swap detector, which is coupled to sense a voltage on at least one of the phone connector and the line connector while the telephone handset is disconnected from the telephone line so as to detect, responsively to the voltage, whether the telephone handset and telephone line have been properly connected.

2. The adapter according to claim 1, and comprising a switch, which is operative selectably under control of the computer to connect the phone connector to the line connector, so as to permit the handset to be used in a telephone call via the telephone line, and to disconnect the phone connector from the line connector for testing by the jack swap connector.

3. The adapter according to claim 2, wherein the jack swap detector is coupled to provide an input to the computer via the computer interface in order to enable the computer determine whether the telephone handset and telephone line have been properly connected, so as to cause the computer to notify a user upon detection of improper connection of the telephone handset and telephone line.

4. The adapter according to claim 2, wherein the jack swap detector is coupled to provide an input to the computer via the computer interface in order to enable the computer determine whether the telephone handset and telephone line have been properly connected, so as to cause the computer to set the switch to disable the adapter upon detection of improper connection of the telephone handset and telephone line.

5. The adapter according to claim 1, and comprising an analog front end (AFE), coupled between the phone connector, line connector and computer interface, and arranged to convert digital input samples received from the computer via the computer interface into analog signals, and to convert the analog signals in the telephone adapter to digital output samples for transfer to the computer via the computer interface.

6. The adapter according to claim 5, and comprising switching circuitry, which is controllable by the computer via the computer interface so as to enable the telephone handset to be used as an audio input/output (I/O) device for a packet telephony application running on the computer.

7. Communication apparatus, comprising:
a telephone adapter, comprising:
a phone connector, for connecting to a telephone handset;
a line connector, for connecting to a telephone line;
a computer interface; and
a jack swap detector, which is coupled to detect whether the telephone handset and telephone line have been properly connected; and
a computer, which is coupled to the computer interface so as to receive an input from the jack swap detector indicating whether the telephone handset and telephone line have been properly connected, and to take protective action upon detection of improper connection of the telephone handset and telephone line.

8. The apparatus according to claim 7, wherein the protective action comprises notifying a user of the improper connection.

9. The apparatus according to claim 7, wherein the protective action comprises disabling the telephone adapter.

10. The apparatus according to claim 7, wherein the telephone adapter comprises:
an analog front end (AFE), which is coupled between the phone connector, line connector and computer interface, and is arranged to convert digital input samples received from the computer via the computer interface into analog signals, and to convert the analog signals in the telephone adapter to digital output samples for transfer to the computer via the computer interface; and
switching circuitry, which is controllable by the computer via the computer interface so as to enable the telephone handset to be used as an audio input/output (I/O) device for a packet telephony application running on the computer.

11. A telephone adapter, comprising:
a phone connector, for connecting to a telephone handset;
a line connector, for connecting to a telephone line of a circuit-switched telephone network;
a computer interface, for connecting to a computer;
an analog front end (AFE), for converting digital input samples received from the computer via the computer interface into analog audio signals, and for converting the analog audio signals in the telephone adapter to digital output samples for transfer to the computer via the computer interface; and
switching circuitry, coupled to convey the analog audio signals simultaneously between the phone connector, line connector and AFE, so as to connect a first subscriber using the telephone handset in a conference call with a second subscriber on the circuit-switched telephone network and with a third subscriber in communication with the computer via a packet-switched network.

12. The adapter according to claim 11, and comprising a jack swap detector for determining whether the telephone handset and the telephone line have been properly connected to the phone connector and the line connector.

13. Communication apparatus, comprising:
a telephone adapter, comprising:
a phone connector, for connecting to a telephone handset;
a line connector, for connecting to a telephone line of a circuit-switched telephone network;
a computer interface;
an analog front end (AFE), for converting digital input samples received from the computer interface into analog audio signals, and for converting the analog audio signals in the telephone adapter to digital output samples for transfer via the computer interface; and
switching circuitry, coupled between the phone connector, line connector and AFE; and
a computer, which is coupled to the telephone adapter via the computer interface and is arranged to set the switching circuitry to convey the analog audio signals simultaneously between the phone connector, line connector and AFE, so as to connect a first subscriber using the telephone handset in a conference call with a second subscriber on the circuit-switched telephone network and with a third subscriber in communication with the computer via a packet-switched network.

14. The apparatus according to claim 13, wherein the computer is arranged to establish a Voice over Internet Protocol (VoIP) call over the packet-switched network with the third subscriber, and to convert the digital output samples to packetized audio data for transmission in the VoIP call.

15. The apparatus according to claim 14, wherein the computer is arranged to establish the VoIP call between the first and third subscribers, and responsively to a signal from the first subscriber during the VoIP call, to control the switching circuitry so as to permit a telephone call to be placed between the telephone handset and the second subscriber and to conference the telephone call with the VoIP call.

16. The apparatus according to claim 15, wherein the adapter and the computer are arranged so as to permit the telephone call to be placed between the telephone handset and the second subscriber without interrupting the VoIP call.

17. The apparatus according to claim 14, wherein the computer is arranged to control the switching circuitry so as to permit a telephone call to be placed between the telephone handset and the second subscriber, and responsively to a signal from the first subscriber during the telephone call, to establish the VoIP call with the third subscriber and to control the switching circuitry so as to conference the telephone call with the VoIP call.

18. The apparatus according to claim 17, wherein the computer is arranged, upon receiving a request from the third subscriber to establish the VoIP call while the telephone call is in progress, to determine that the telephone adapter is in use and to issue a notification to the user indicating that the request is pending.

19. The apparatus according to claim 13, wherein the computer is operative in a voice communication mode to transmit and receive digital audio samples via the computer interface so as to cause the AFE to convey analog audio signals to and from the telephone handset, and is operative in a modem communication mode to transmit and receive digital modem samples via the computer interface so as to cause the AFE to convey modem signals corresponding to the digital output and input data to and from the telephone line.

20. The apparatus according to claim 13, wherein the telephone adapter comprises a jack swap detector for determining whether the telephone handset and the telephone line have been properly connected to the phone connector and the line connector.

21. Communication apparatus, comprising:
a telephone adapter, comprising:
a phone connector, for connecting to a telephone handset;
a line connector, for connecting to a telephone line of a circuit-switched telephone network;
a computer interface; and
an analog front end (AFE), coupled between the phone connector, line connector and computer interface, and arranged to convert digital input samples received via the computer interface into analog signals, and to convert the analog signals in the telephone adapter to digital output samples for transfer via the computer interface; and
a computer, which is coupled to the telephone adapter through the computer interface, and which is operative in a voice communication mode to transmit and receive digital audio samples via the computer interface so as to cause the AFE to convey analog audio signals to and from the telephone handset, and which is operative in a modem communication mode to transmit and receive digital modem samples via the computer interface so as to cause the AFE to convey modem signals corresponding to digital output and input data to and from the telephone line.

22. The apparatus according to claim 21, wherein the telephone adapter comprises switching circuitry, coupled to selectably convey the analog signals between the phone connector, line connector and AFE, and wherein the computer is coupled to control the switching circuitry via the computer interface.

23. The apparatus according to claim 21, wherein the computer is arranged to run a soft modem program, for processing the digital output data to generate the digital output samples for conveyance to the AFE and for processing the digital input samples received from the AFE to generate the digital input data.

24. The apparatus according to claim 23, wherein the soft modem program is operative in accordance with at least one of an analog modem standard and a fax modem standard.

25. Communication apparatus, comprising:
a telephone adapter, comprising:
a phone connector, for connecting to a telephone handset;
a line connector, for connecting to a telephone line of a circuit-switched telephone network, and coupled to the phone connector so as to establish a first telephone call between the telephone handset and a subscriber on the circuit-switched telephone network;
a computer interface; and
an analog front end (AFE), coupled between the phone connector and the computer interface, and arranged to convert digital input samples received via the computer interface into analog audio signals, and to convert the analog audio signals in the telephone adapter to digital output samples for transfer via the computer interface; and
a computer, which is coupled to the telephone adapter through the computer interface, and which is further coupled to receive a request to open a second telephone call over a packet-switched network and, responsively to the request, to determine that the telephone adapter is in use on the first telephone call and to issue a notification to the user indicating that the request is pending.

26. A method for communication, comprising:
providing a telephone adapter that includes a phone connector, for connecting to a telephone handset, a line connector, for connecting to a telephone line, and a computer interface, for connecting to a computer; and
after a user has connected the telephone handset and the telephone line to the telephone adapter, sensing a voltage on at least one of the phone connector and the line connector while disconnecting the telephone handset from the telephone line so as to detect, responsively to the voltage, whether the telephone handset and telephone line have been properly connected.

27. The method according to claim 26, wherein disconnecting the telephone handset comprises operating a switch in the telephone adapter under control of the computer to disconnect the phone connector from the line connector while sensing the voltage, and to connect the phone connector to the line connector, so as to permit the handset to be used in a telephone call via the telephone line.

28. The method according to claim 26, wherein sensing the voltage comprises providing a signal to the computer indicating whether the telephone handset and telephone line have been properly connected, so as to cause the computer to notify a user upon detection of improper connection of the telephone handset and telephone line.

29. The method according to claim 26, wherein sensing the voltage comprises providing a signal to the computer indicating whether the telephone handset and telephone line have been properly connected, so as to cause the computer to disable the adapter upon detection of improper connection of the telephone handset and telephone line.

30. The method according to claim 26, and comprising converting digital input samples received from the computer via the computer interface into analog signals in the telephone adapter, and converting the analog signals in the telephone adapter to digital output samples for transfer to the computer via the computer interface, so as to enable the telephone handset to be used as an audio input/output (I/O) device for a packet telephony application running on the computer.

31. A method for communication, comprising:
connecting a telephone handset, a telephone line, and a computer to a telephone adapter;
connecting a first subscriber using the telephone handset via the telephone adapter in a conference call with a second subscriber on the circuit-switched telephone network and with a third subscriber in communication with the computer through a packet-switched network; and
during the conference call, operating the telephone adapter to convert digital input samples received from the computer via the computer interface into analog audio signals, and to convert the analog audio signals in the telephone adapter to digital output samples for transfer to the computer via the computer interface, and simultaneously to convey the analog audio signals between the telephone adapter and the telephone handset and telephone line so as to permit the first, second and third subscribers to converse.

32. The method according to claim 31, wherein connecting the first subscriber with the third subscriber comprises establishing a Voice over Internet Protocol (VoIP) call over the packet-switched network between the computer and the third subscriber, and converting the digital output samples to packetized audio data for transmission in the VoIP call.

33. The method according to claim 32, wherein connecting the first subscriber with the second subscriber comprises controlling the telephone adapter, responsively to a signal from the first subscriber during the VoIP call, so as to permit a telephone call to be placed between the telephone handset and the second subscriber and to conference the telephone call with the VoIP call.

34. The method according to claim 33, wherein controlling the telephone adapter comprises placing the telephone call between the telephone handset and the second subscriber without interrupting the VoIP call.

35. The method according to claim 32, wherein connecting the first subscriber with the second subscriber comprises placing a telephone call between the telephone handset and the second subscriber, and responsively to a signal from the first subscriber during the telephone call, establishing the VoIP call with the third subscriber.

36. The method according to claim 35, and comprising, upon receiving a request from the third subscriber to establish the VoIP call while the telephone call is in progress, determining that the telephone adapter is in use and notifying the user that the request is pending.

37. A method for communication, comprising:
connecting a telephone handset, a telephone line, and a computer to a telephone adapter, which is arranged to convert digital input samples received from the computer into analog signals for output to the telephone handset and the telephone line, and to convert the analog signals received from the telephone handset and the telephone line to digital output samples for transfer to the computer;
operating the computer in a voice communication mode to transmit and receive digital audio samples via the computer interface so as to cause the telephone adapter to convey analog audio signals to and from the telephone handset; and
operating the computer in a modem communication mode to transmit and receive digital modem samples via the computer interface so as to cause the AFE to convey modem signals corresponding to digital output and input data to and from the telephone line.

38. The method according to claim 37, wherein the telephone adapter comprises switching circuitry, coupled to selectably convey the analog signals between the phone connector, line connector and computer, and comprising operating the switching circuitry under control of the computer to select the voice communication mode or the modem communication mode.

39. The method according to claim 37, wherein operating the computer in the modem communication mode comprises running a soft modem program on the computer for processing the digital output data to generate the digital output samples for conveyance to the telephone adapter and for processing the digital input samples received from the telephone adapter to generate the digital input data.

40. The method according to claim 39, wherein the soft modem program is operative in accordance with at least one of an analog modem standard and a fax modem standard.

41. A method for communication, comprising:
connecting a telephone handset, a telephone line and a computer to a telephone adapter, which is arranged to convert digital input samples received from the computer into analog signals for output to the telephone handset and the telephone line, and to convert the analog signals received from the telephone handset and the telephone line to digital output samples for transfer to the computer;
establishing a first telephone call, using the telephone adapter, between the telephone handset and a subscriber on the circuit-switched telephone network;
receiving a request at the computer to open a second telephone call over a packet-switched network while the telephone adapter is in use on the first telephone call; and
responsively to the request, notifying the user that the request is pending.
